(19) United States
(12) Patent Application Publication
(10) Pub. No.: US 2025/0336201 A1
(43) Pub. Date: Oct. 30, 2025

(54) GENERATION OF RESULT IMAGE DATA FROM ORIGIN DATA BASED ON A MEDICAL IMAGING

(71) Applicant: Siemens Healthineers AG, Forchheim (DE)

(72) Inventors: Uwe Fabricius, Erlangen (DE); Philipp Bernhardt, Forchheim (DE); Stefan Böhm, Oberasbach (DE); Richard Obler, Erlangen (DE)

(21) Appl. No.: 19/185,698

(22) Filed: Apr. 22, 2025

(30) Foreign Application Priority Data
Apr. 26, 2024 (DE) 10 2024 203 947.0

(51) Int. Cl. G06V 10/94; G06V 10/26; G06V 10/30; G06V 10/36; G06V 10/764; G06V 10/82

(52) U.S. Cl. CPC G06V 10/955; G06V 10/36; G06V 10/82; G06V 10/26; G06V 10/30; G06V 10/764; G06V 2201/03

(57) ABSTRACT

A method for generating result image data from origin data includes a part algorithm generated as a function of input data and a parameter setting generated as output data. The parameter setting of at least one part algorithm is predetermined as a function of a control parameter of an overall processing algorithm. First and second limit values are assigned first and second values of the parameter setting, wherein that of the first value for the at least one part algorithm leads to the output data of the at least one part algorithm deviating more greatly from the input data of that of the part algorithms or from reference data, which would result on application of a reference algorithm assigned to the at least one part algorithm to this input data, than with using the second value of the parameter setting of the respective part algorithm.

The present patent document claims the benefit of German Patent Application No. 10 2024 203 947.0, filed Apr. 26, 2024, which is hereby incorporated by reference in its entirety.

### TECHNICAL FIELD

The disclosure relates to a computer-implemented method for generation of result image data from origin data that is based on a medical imaging method, by an overall processing algorithm that includes a number of part algorithms. The disclosure also relates to a processing apparatus, to a computer program, and to a data medium.

### BACKGROUND

In medical imaging, a series of image processing algorithms may be applied to the physically detected image, (e.g., to the image recorded by an x-ray detector, as part of a reconstruction of image data from measurement data, and/or after such a reconstruction), in order to prepare the image as well as possible for the intended usage purpose. Reconstruction algorithms for creation of slice images from projection recordings, denoising algorithms for reduction of quantum noise in x-ray images or also segmentation algorithms for emphasizing relevant structures are used as image processing algorithms for example.

Here, the image obtained from the purely physical processes, (which may also be referred to as the raw image and which may be considered as the image closest to reality), is modified in a wide variety of ways. With each processing stage, the processed image removes data from the raw image with regard to image values and/or image representation in a desired and, in some cases, additionally in an undesired way. The undesired modifications may include algorithmic artifacts, which are willingly taken into account for the desired effects. A known example of such artifacts are “halos,” e.g., over-bright areas in the area of edges during the modification of the frequency spectrum.

In particular, when at least one artificial intelligence image processing algorithm is used that attempts to interpret image contents, the results of the processing are not necessarily verifiable for an observer. During processing, assumptions are made about properties and contents of the image in order to generate the processed image. With such processing, familiar image properties and their relationships may become lost for the observer. Thus, an interpreting denoising algorithm might free a dose-related noisy image from noise to an extent that the impression of a high-dose image arises, in which the recognizable structures would actually have corresponded to the real information content of the original image. An interpreting algorithm might thus represent its interpretation as actually present information in this case, even if actually only insufficient image information might be available. Frequently with such processing, this also does not result in easily detectable artifacts, which may inform the observer how greatly the processed image deviates for the “truth,” e.g., from the original raw image.

### SUMMARY AND DESCRIPTION

The scope of the present disclosure is defined solely by the appended claims and is not affected to any degree by the statements within this summary. The present embodiments may obviate one or more of the drawbacks or limitations in the related art.

The underlying object of the disclosure is to support a user in the assessment of result image data resulting from an overall processing algorithm and to make it possible for the user to assess how greatly and/or in what way the result image data deviates for the processed origin image data.

The object is achieved by a computer-implemented method for generation of result image data from origin data that is based on a medical imaging method, by an overall processing algorithm that includes a number of part algorithms, wherein the part algorithm, depending on respective input data and at least one respective parameter setting, generates respective output data. The input data of the part algorithms is predetermined by the origin data predetermined or is established from the origin data. The result data is established depending on the output data of the part algorithms. The parameter setting for at least one part algorithm is predetermined depending on a control parameter of the overall processing algorithm, wherein the control parameter is adjustable by an operator input of the user continuously or in at least three stages between a first and a second limit value. The first limit value is assigned a first value of the parameter setting and the second limit value is assigned a second value of the parameter setting for the at least one part algorithm. Setting the first value of the parameter setting for the at least one part algorithm, at least for a subgroup of the possible origin data, leads to the output data of the at least one part algorithm or of the number of part algorithms deviating more greatly from input data or from reference data that would result from an application of a reference algorithm assigned to the at least one part algorithm or to the number of part algorithms to this input data than by setting the second value of the parameter setting.

The user, e.g., the observer of the result image data or of an image established from this, for example, of a slice image or of an artificial projection image, may be able to recognize to what extent the appraised image reflects the real information content of the imaging. The method gives them the opportunity here of easily changing this extent in order to make this assessment possible and in order to adapt the image to current requirements. T his is made possible by the user, by setting a single parameter, namely the control parameter, being able to vary the origin data, continuously or at least in a number of stages between various processing strengths. In particular, the control parameter is able to beset effectively continuously, e.g., in a plurality of stages such as in at least 10 stages, at least 20 stages, or at least 50 stages.

By setting the control parameter to the second limit value, the raw image or an image that results from minimal processing may be shown. By setting the control parameter to the first limit value, a maximum optimization of the image impression for the given task may result. Through a multi-stage or continuous transition between these degrees of processing, the effects of the various part algorithms in particular may be well verified by the user, so that erroneous image impressions may be removed. To do this in particular, as explained in greater detail below, various parts of the image processing in particular in various parameter ranges of the control parameter may be deactivated or attenuated.

In particular, it is possible that the control parameter and thus the strength of the change to the image are shown together with the result image data or the image established from the data, in order to make this information directly accessible to the user. The control parameter may be displayed directly as an operating element, for example, as a regulator, in order to make a dynamic adaptation possible as required.

The opportunity of setting the control parameter or the operating element explained also make it possible for the user to set an individual degree of image data processing dynamically and in line with requirements. For example, a doctor undertaking the treatment in an angiography for navigation of devices using fluoroscopy may allow a high degree of algorithmic interpretation in favor of a noise-free and clear representation but lower this for diagnostics using a higher x-ray dose and/or for exact placement of implants.

The origin data may directly involve measurement data or data already preprocessed, for example, three-dimensional image data already reconstructed. The origin data may be based on a magnetic resonance imaging, an x-ray imaging such as a computed tomography or a fluoroscopy, an ultrasound imaging, or on any other given medical imaging method. The imaging itself may not be part of the method described herein. The imaging may have already been concluded and the origin data may be taken from a database or similar. The imaging may alternatively be integrated into the method as an additional method act.

The part algorithms may be switched in series after one another so that a first of the part algorithms processes the origin data and the others of the part algorithms each further process the output data of the preceding part algorithm. It is also possible for at least parts of the part algorithms to be applied in parallel, e.g., in order to separately process various frequency ranges of the origin data or of an intermediate result. For further processing by at least one further of the part algorithms or for provision of the result image data, the output data of the part algorithms operating in parallel may be summed in a weighted manner, for example.

The second value of the parameter setting of the respective part algorithm may lead, at least for one subgroup of the part algorithms, to the output data of the respective part algorithm being identical to the input data of this part algorithm, whereby the part algorithms of this subgroup would be effectively skipped, with a setting of the control parameter to the second limit value. It is also possible for the second value of the parameter setting of the respective part algorithm to continue to change the input data, but to lead to a less strong processing of the respective input data than the first value of the parameter setting. For example, the strength of a filtering or a spectral shaping, which may serve to suppress noise and/or to reduce the low-frequency dynamics, and/or the strength of an edge rise may be varied. The strength of the deviation of the output data of the respective part algorithm from its input data may be quantified by deviation measures, for example, by a sum of the squares of the differences in the individual pixels or voxels.

The reference algorithm may bean algorithm for which it is assumed that the algorithm is passing on the data uncorrupted. An observation of the deviation of reference data may be expedient when data processing is necessarily required in the respective part algorithm, for example, in order to carry out an image reconstruction, as may be required for magnetic resonance data and for the reconstruction of a computed tomography from an individual projection image. A pure reconstruction algorithm without further image preparation properties may be regarded as a reference algorithm, for example.

In particular, a choice may be made by various settings of the control parameter continuously or at least in a number of stages between a strong and a weaker change in the data by the respective part algorithm, so that by an adjustment of the control parameter toward the limit value, the result data approaches the origin data or reference data, which may be generated from the origin data by quite simple processing, for example, by a direct reconstruction with minimal filtering and without any other image optimization acts.

The subgroup of the possible origin data may include all origin data that occurs with an adequate image quality during imaging of a patient. For example, only origin data that does not image any real object and/or that is primarily hallmarked by noise elements or the like may lie outside the subgroup. Corresponding incorrect measurements may lead to origin data for which processing leads to unexpected results, so that the condition stated above for the subgroup is not necessarily met in these cases.

In one example, or when a direct algorithmic parameterization of the strength of the effect of processing an image by the respective part algorithm is not readily possible, which may be the case with neural networks or other trained processing functions, the effect of any given image processing P of input data u by a parameter value λ∈ [0,1] of the parameter setting and the scaled addition of the difference image may be parameterized:

$$u ↦ u + λ ( P ( u ) - u ) = ( 1 - λ ) u + λ P ( u )$$

If the parameter value λ is set to 1, the maximum processing strength results. Lowering this parameter value results in weaker processing, wherein for a parameter value of λ=0 the part algorithm is effectively skipped.

The respective part algorithm may be assigned a respective assignment specification, which allocates a parameter setting of the assigned part algorithm to the first and second limit value and to at least one intermediate value lying between the first and second limit value of the control parameter, wherein assignment specifications that are assigned to at least two of the part algorithms describe relationships differing from one another between the respective parameter setting and the control parameter.

For example, the parameter settings of the various part algorithms may be predetermined by a respective function of the control parameter or may be selected so that they lie at such a function, e.g., when they are predetermined by a Look-U p Table or the like. The various relationships between the respective parameter setting and the control parameter may result from different rises and/or curvatures of the respective function for at least one of the control parameter values.

The respective parameter setting may predetermine a respective parameter value of at least one parameter of the respective part algorithm, wherein the respective parameter value is a monotonously rising or falling function of the control parameter in each case.

The part algorithms may be parameterized in such a way that, at least for the subgroup of the possible origin data, an increase in the respective parameter value leads to a strengthening or to a reduction in the deviation of the output data from the input data of the respective part algorithm or from the reference data. As a result of the monotonous relationship between parameter value and control parameter explained above, it may be provided that, when the control parameter is changed toward the second limit value for each of the part algorithms, the deviation of the respective output data from the respective input data or reference data falls or at least remains the same, so that it may be assumed that here the result data overall is close to the origin data or at least to an image generated or reconstructed from the origin data with the minimum image manipulations.

It may be advantageous if, at least for a few of the part algorithms or parameter values, the monotonous function does not rise or fall strictly monotonously but remains constant for specific ranges of values of the control parameter constant. In particular, functions for establishing parameter values of different part algorithms in ranges of values of the control parameter differing from one another may be constant, so that the processings by the individual part algorithms for a variation of the control parameter may be faded out or deactivated separately one after another or also with overlapping cross-fade areas.

The maximum of the at least one parameter value of the parameter setting of a first of the part algorithms may be reached for a value of the control parameter other than the maximum of the at least one parameter value of the parameter setting of a second of the part algorithms. In addition, or as an alternative, the minimum of the at least one parameter value of the parameter setting of a first of the part algorithms may be reached for a value of the control parameter other than the minimum of the at least one parameter value of the parameter setting of a second of the part algorithm.

In particular, for more than two, in particular for all part algorithms or at least for all part algorithms switched after one another in series, maxima or minima of their parameter values may be reached for different values of the control parameter in each case, so that, in different sections of the range of values of the control parameter, a processing by different the part algorithms may be faded out or attenuated or be replaced by processing that potentially corrupts the image less greatly.

In particular, the respective function, which predetermines the respective parameter value as a function of the control parameter, may be constant over a respective range of values and equal to the maximum or the minimum of the parameter value. By reaching the maximum or the minimum of the parameter value of the different part algorithms with different values of the control parameter, enables the ranges, in which the respective parameter value is constant, to not overlap or only partly to overlap, so that there may be a change of the parameter values of the different part algorithms in different ranges of values of the control parameter.

At least two of the functions, which each predetermine a different parameter value of the part algorithms or predetermine the different parameter values of the same part algorithm as a function of the control parameter, may have a different curvature and a curvature that differs from zero over the entire range of values of the control parameter or at least over a part of the range of values of the control parameter.

In particular, the curvatures of two such functions may have different leading signs. By different curvatures, in particular by curvatures with different leading signs, the two functions may even be reached with a coincidence of the maxima and minima of the two functions, so that in a first range of values of the control parameter a first of the two parameter values is greatly changed, while a second of the parameter values remains almost constant, while in a second range of values of the control parameter the first of the parameter values remains almost constant and the second of the parameter values is greatly changed. Thus, in particular in the first of the ranges of values, one of the part algorithms is faded out or at least largely deactivated, while another part algorithm initially continues to be applied unchanged. Only when the second range of values is reached is the other part algorithm also appreciably attenuated or faded out.

The overall processing algorithm may include a processing algorithm based on a segmentation and/or classification of the respective input data as the first of the part algorithms or a processing algorithm based on machine learning and a filter algorithm as the second of the part algorithms. In this case, the functions of the control parameter predetermining the parameter values of the first and second part algorithm may be selected in such a way that, at least for control parameters that lie within a predetermined control parameter interval, the amount of the quotient of the difference between the parameter value assigned to the control parameter and the corresponding parameter value assigned to the second value of the parameter setting and the difference between the parameter values that are assigned to the respective first and second value of the parameter setting is greater for the second part algorithm than it is for the first part algorithm.

For easier understanding of the requirement discussed above, it is assumed below, for example, that each of the part algorithms is only parameterized by one parameter value and that the respective parameter value is 1 for the first value of the parameter setting 1 and is 0 for the second value of the parameter setting. In this case, the result of the requirement is that the parameter value of the first part algorithm in the predetermined control parameter interval is less than the parameter value of the second part algorithm. To put it differently, regardless of the restriction of the parameter range to 0 to 1 used in the example, at least in the predetermined control parameter interval, the processing by the first part algorithm is more greatly attenuated than the processing by the second part algorithm.

This is advantageous since processing algorithms based on a segmentation and/or classification of the respective input data or on machine learning may change the impression of the image greatly and under some circumstances in a way not readily appreciated by an observer. The embodiment of the method explained thus makes it possible, within the framework of the adjustment of the control parameter toward the second limit value, initially to fade out these changes, but, for example, to retain unchanged filtering for noise suppression, for reduction of a low-frequency dynamic and/or for edge enhancement.

Outside the predetermined control parameter interval, the parameter values, or quotients may be the same for both part algorithms. In particular, control parameters may lie exclusively outside the predetermined control parameter interval, for which the increase of the respective function is zero and thus both parameter values are constant.

The overall processing algorithm, in addition or as an alternative, may include as part algorithms a first filter algorithm for adapting the spectral portions in a first frequency band and a second filter algorithm for adapting the spectral portions in a second frequency band of the origin data or of an intermediate result established using at least one of the part algorithms, wherein the first frequency band extends to higher frequencies than the second frequency band. In this case, the functions of the control parameter predetermining the parameter values of the first and second filter algorithm may be chosen in such a way that, at least for control parameters that lie within one or a further predetermined control parameter interval, the amount of the quotient of the difference between the parameter value assigned to the control parameter and the parameter value corresponding to the second value of the parameter setting and the difference between the parameter values that are assigned to the respective first and second value of the parameter setting is greater for the second filter algorithm than it is for the first filter algorithm.

Thus, as has already been explained above for the first and second part algorithm, at least in the or the further predetermined control parameter interval, the processing by the first filter algorithm may be more greatly attenuated than the processing by the second filter algorithm. This may be advantageous since a change in the mid to high frequency ranges may lead to marked artifacts, for example, to “halos,” while with a change in the spectral composition in the low-frequency range, e.g., with a reduction of the low-frequency dynamic, fewer artifacts or fewer obvious artifacts may occur. The parameterization explained as a function of the control parameter may thus make it possible for a user to first attenuate or fade out any kind of processing that frequently leads to a relatively strong artifact formation, wherein the less problematic adaptation of the lower frequency components may be retained unchanged.

If, for example, a reduction of the low-frequency dynamic, a change in the range of the high to mid image frequencies, for example, for edge enhancement, and a processing algorithm based on a classification of image contents are used as part algorithms, then with an adjustment of the control parameter from the limit value toward the second limit value, at the beginning of the adjustment path, only the processing based on the classification is deactivated or faded out. Only with a value of the control parameter, for which this is already largely deactivated, may a start be made on the fading out of the filtering in the mid and/or high frequency range and only after a marked reduction or fading out of this filtering may the filtering for reducing the low-frequency dynamics be attenuated or faded out.

As explained in greater detail below, a spectral decomposition algorithm may also be used to supply various part algorithms with various spectral components of the origin data or of the intermediate result. In this case, the respective filter algorithm may be implemented by there being a scaling of one or more of the spectral components by a respective part algorithm.

The overall processing algorithm may include a number or all of the following part algorithms: an algorithm for edge enhancement, a filter algorithm such as for reduction of a low-frequency dynamic, a processing algorithm based on a segmentation and/or classification of the respective input data, and/or a processing algorithm based on machine learning and/or a scaling of the input data. Thus, in the computer-implemented method, for example, the entire processing chain or also just parts of the processing chain may be parameterized by the control parameter.

A segmentation or classification of the respective input data of the part algorithm may be used to carry out a color coding of the image as a function of a classification of image contents, to highlight or suppress image regions and thus the features shown there as a function of the classification or segmentation, for example, by increasing or reducing the brightness or the contrast in segments with a specific classification, for highlighting specific segments by a surround or similar.

The processing algorithm based on machine learning may carry out a classification and/or segmentation of input data in order to use this in the way already explained. It is also possible for the desired overall functionality to be trained directly, for example, the color coding of specific segments, so that a classification or segmentation does not necessarily take place explicitly within this algorithm.

A processing algorithm based on machine learning may emulate the cognitive functions, which make the connection between humans and human thinking. By training on the basis of training data, such a processing algorithm may be capable of adapting itself to new circumstances and recognizing and extrapolating patterns. Such a processing algorithm may also be referred to as a “trained machine learning model” or “trained function.”

The parameters of a machine learning model may be adapted by training. In particular, a supervised training, a semi-supervised training, an unsupervised training, a reinforcement learning, and/or an active learning may be used. Further, representation learning or feature learning may also be employed. In particular, the parameters of the machine learning models may be adapted iteratively by a number of training acts. In particular, a specific cost function may be minimized within the framework of the training. In particular, the backpropagation algorithm may be used during training of a neural network.

A machine learning model may in particular include a neural network, a support vector machine, a decision tree, and/or a Bayesian network, and/or the machine learning model may be based on k-means clustering, Q learning, genetic algorithms, and/or association rules. A neural network may be a Deep Neural Network, a Convolutional Neural Network, or a Convolutional Deep Neural Network sein. Alternatively, the neural network may bean adversarial network, a deep adversarial network, and/or a generative adversarial network.

A highpass filter, a lowpass filter, and/or a bandpass filter may be used as filter algorithm or as filter algorithms, for example. The filter algorithm or at least one of the filter algorithms used as part algorithm may also carry out any given spectral shaping of its input data.

For implementing a complex spectral shaping or filtering, it may also be expedient to use a number of separate part algorithms that each differently scale various spectral components of the origin data or of an intermediate result provided by at least one of the further part algorithms.

In one case, an edge enhancement may be implemented by the enhancement of higher frequencies in an image. One realization is the scaled addition of a highpass image:

$$u ↦ u + λ \cdot {λ}_{m ax} H ( u )$$

wherein u is the input image and H (u) a highpass image of u.

The parameter value λ∈ [0,1] is suitable here for parameterizing the effect of the edge enhancement from “no effect” at λ=0 up to a maximum effect at λ=1.

A reduction of the low-frequency dynamic may be employed to use the available gray value range for relevant information. One realization is the scaled subtraction of a lowpass image:

$$u ↦ u - λ L ( u ) + λ \overline{u}$$

wherein u here is the input image, L(u) is a lowpass image of u, and ū is the average value of u. λ is suitable here for parameterizing the suppression of the low-frequency dynamic from “no effect” at λ=0 up to a maximum effect at λ=1.

The overall processing algorithm, as well as the part algorithms, may include a spectral decomposition algorithm, which provides as output data a number of spectral components of the origin data or of an intermediate result established by using at least one of the part algorithms, wherein a number of or all of the spectral components are each processed as input data by one of the part algorithms.

The separate processing of a number or all spectral components by a respective part algorithm enables any given spectral shaping to be implemented, wherein in particular by different dependencies of the parameter settings of the various part algorithms on the control parameter what may be achieved is that the strength of the processing of the respective spectral component may be varied within the framework of the adjustment of the control parameter for the various spectral components independently of one another.

The output data of the part algorithms processing the spectral components may subsequently be merged again, for example, added to one another, in order to provide the result data or input data for at least one further part algorithm. The spectral decomposition algorithm may be implemented by a Gauss-Laplace pyramid, a Fourier transformation, or similar.

In one case, the part algorithms that process the spectral components as input data may scale the respective input data, wherein the scaling factors for an adjustment of the control parameter in the direction of the second limit value may be adjusted increasingly in the direction of the factor 1, so that a suppression or highlighting of the respective spectral area may be reduced or deactivated by the adjustment of the control parameter. As described below, more complex spectral shapings or non-linearities of the processing of the individual spectral components are possible.

A spectral shaping of an image might be undertaken via a decomposition of the image u into components cᵢ(i=1, . . . , n), for example, by a Gauss-Laplace pyramid. The input image of the spectral decomposition is then, at least approximately, replicated by summation of the spectral components cᵢ in accordance with

$$u = {\sum }_{1 = 0}^{n} {c}_{i} .$$

In one case, the processing is carried out by a scaling of the respective spectral components by one of the respective part algorithms:

$$u ↦ {\sum }_{i = 1}^{n} {α}_{i} {c}_{i}$$

Any given spectral reshapings are possible by selection of the scaling factors aᵢ. The effect of this processing may be scaled in one case by a common parameter value λ∈ [0,1]:

$$u ↦ {\sum }_{i = 1}^{n} [ ( 1 - λ ) + λ {α}_{i} ] {c}_{i}$$

A more complex effect of the parametrization by λ∈ [0,1] is conceivable when the scaling vector α itself is a sum of vectors, of which each in this context has a dedicated effect on the processed image. In this way, the edge enhancement described above and the lowering of the low-frequency dynamic might each be implemented by a suitable scaling vector α within the framework of the frequency decomposition. This approach is able to be expanded to any given number m of scaling vectors α^{(j)} each with a dedicated effect. For differentiating the effect of the parameter λ on the vectors α^{(j)} functions Γ^{(j)}: [0,1]→[0,1] mit Γ^{(j)}(0)=0 and Γ^{(j)}(1)=1 are defined in the example so that a parameterized image processing is produced as follows:

$$u ↦ {\sum }_{i = 1}^{n} {\sum }_{j = 1}^{m} [ ( 1 - {Γ}^{( j )} ( λ ) ) + {Γ}^{( j )} ( λ ) {α}_{i}^{( j )} ] {c}_{i}$$

Here, there is no processing for λ=0 and the processing takes its full effect for λ=1. By selection of different shapes, for example, different curvatures, of the functions Γ^{(j)} the actual behavior of the processing may be defined as a function of λ. For example, through this, the scaling of the high frequencies for edge enhancement may already be faded out quite close to the first limit value of the control parameter, in that for the function Γ^{(j)} for the relevant frequency range or the relevant frequency ranges, a high increase is selected there. Further, the function Γ^{(j)}, which scales the processing of the low frequencies, may be almost flat close to the first limit value of the control parameter and only have a steep section in the area close to the second limit value, so that the reduction of the low-frequency dynamic is only faded out relatively late during the adjustment of the control parameter toward the second limit values.

For the sake of completeness, it is pointed out that, instead of the summation of the scaling vectors α^{(j)}, a product of the scaling vectors α^{(j)} may also be used. This corresponds to a concatenation of various filter processes of which the frequency curve is described in each case by the respective scaling vector α^{(j)}.

In addition, or as an alternative, to a pure scaling of the spectral components, a non-linear processing may also be used:

$$u ↦ {\sum }_{i = 1}^{n} {β}_{i} ( {c}_{i} )$$

Here, βᵢ describes a suitable non-linear function for processing the respective spectral component cᵢ. Artifacts, e.g., disruptive artifacts, generated by the linear approach, may be reduced by this, with a strongly marked non-linearity the corresponding points in the image may also be misinterpreted. The parameter value λ∈ [0,1] may in this case bring about a steady transition of βᵢ to a linear function, for example, in that a weighted sum of the linear and the non-linear function is calculated, wherein λ or (λ-1) are used as weighting factors.

At least one of the part algorithms may include a first and a second alternative algorithm, wherein the respective alternative algorithm is configured to process the input data in order to provide respective alternative data. The parameter setting of the respective part algorithm then enables a choice to be made between the use of the first and second alternative algorithm for provision of the respective alternative data as output data. As an alternative, the output data may be provided by a cross fading between the alternative data of the first and of the second alternative algorithm as a function of the parameter setting.

The use of various alternative algorithms may make possible a more flexible adaptation of the image impression than would be possible when exclusively using different parameterizations of the same algorithms. For example, there may be a cross fading here between a denoising by a trained algorithm and a denoising by a lowpass filter or also between an iterative reconstruction and a reconstruction by backprojection.

The overall processing algorithm may include a number of sub-algorithms, wherein the respective sub-algorithm generates respective output data as a function of respective input data and a respective parameter setting, wherein the input data of the respective sub-algorithm is predetermined by the origin data or is established from the origin data by using at least one other of the part algorithms. In this case, the part algorithms may be selected as a function of configuration information from the sub-algorithms.

In particular, the configuration information may be adapted when an operating action of the user is detected by an operating device or mechanism. The user may thus choose which of the sub-algorithms are to be adapted for an adjustment of the control parameter. For example, the desire on the part of the user may be for there to be an edge enhancement or a noise suppression by a low pass filter independently of the chosen setting of the control parameter.

The control parameter may be output to the user via a display facility. In addition, or as an alternative, a user input of the user may be detected by an operating device, as a function of which the control parameter is set.

The control parameter may be displayed on a display facility, for example, a screen, via which the result image data or a graphical representation established from the result image data is also shown. The display may be shown as a numerical value and/or as a graphical representation, for example, as a bar graphic.

The operating device may involve a physical or virtual slider, shown on a touchscreen, for example. Rotary controls, numerical input fields, or the like may also be used for setting.

As well as the method, the disclosure also relates to a processing apparatus configured for carrying out the computer-implemented method. The processing apparatus may be embodied as suitably programmed data processing faculties or the functionality may alternatively be implemented hard-wired, at least in part. The processing apparatus may be integrated into a medical imaging facility, in particular, into an x-ray facility or a magnetic resonance tomograph, or may be embodied separately from these. It may be implemented as a workstation computer, server, or Cloud solution.

The disclosure also relates to a computer program with instructions configured, when executed on a data processing facility, to carry out the computer-implemented method.

The disclosure also relates to a non-transitory data medium that includes the computer program described herein.

### BRIEF DESCRIPTION OF THE DRAWINGS

Further advantages and details of the disclosure emerge from the embodiments given below and also from the associated drawings. In the schematic drawings:

FIG. 1 depicts an exemplary embodiment of a processing apparatus, which is configured to carry out an embodiment of the method for generation of result image data from origin data.

FIG. 2 depicts a flow diagram of an embodiment of the method.

FIG. 3 depicts an example of the implementation of a part algorithm in the embodiment shown in FIG. 2.

FIG. 4 depicts the dependency of parameter values of the parameter settings of the various part algorithms on the control parameter in the embodiment in accordance with FIG. 2.

FIG. 5 depicts a further embodiment of the method for generation of result image data from origin data.

FIG. 6 depicts the dependency of parameter values of the parameter settings of the various part algorithms on the control parameter in the embodiment in accordance with FIG. 5.

### DETAILED DESCRIPTION

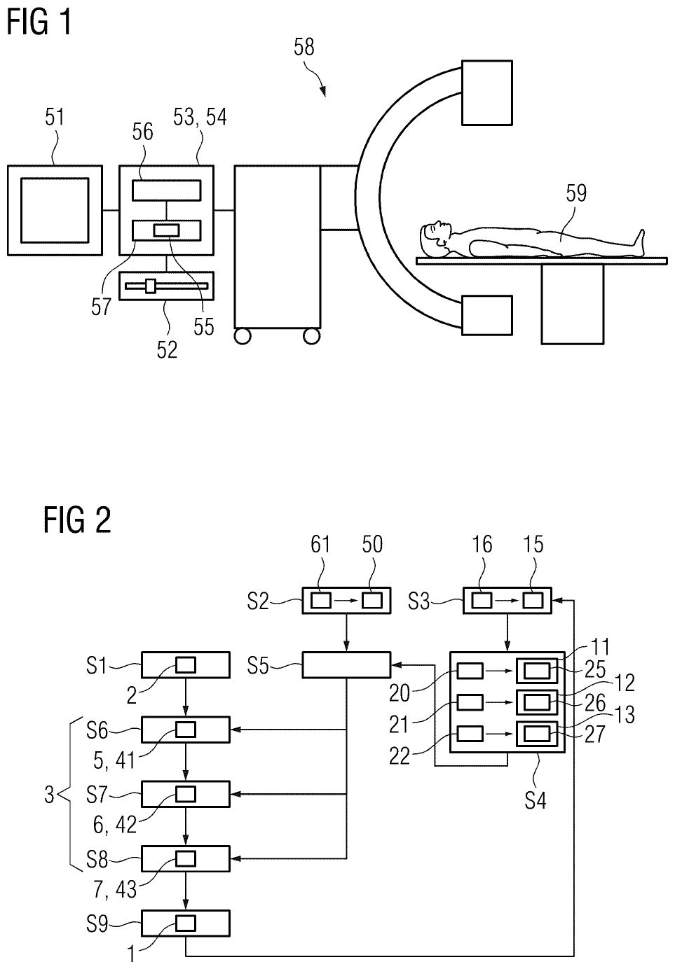

FIG. 1 shows a usage situation in which a method implemented by the processing apparatus 53 is used in order to generate result image data from origin data, which is based on a medical imaging method and which in the example is provided directly by the medical imaging facility 58, which is visualized for a user via a display facility 51.

In the example, the origin data is x-ray data, in particular fluoroscopy data, which has been acquired directly from the patient 59. The method explained in greater detail below may also be used for processing data of other medical imaging methods, for example, of magnetic resonance tomography, of Positron Emission Tomography, or of ultrasound imaging. It is also possible for the origin data to have been acquired spatially and temporally independently of the processing discussed and for the explained processing to have been taken from a database, for example.

The processing of the origin data may serve to enhance the image quality, to give a desired image impression, and/or to highlight or to mark specific features in the result image data for easier recognition by an observer. In addition, or as an alternative, the processing may include the reconstruction of three-dimensional image data and/or the generation of two-dimensional image data from three-dimensional image data, for example, by a forward projection or by selection of slices.

A number of part algorithms are used here, as explained in greater detail below. The individual part algorithms here, within the framework of changing the origin data, as well as making the desired changes, e.g., noise reduction or highlighting relevant features, may also generate undesired side effects. With a strong reduction in noise, for example, the user may be misled into incorrectly interpreting or overinterpreting the result image data, since because of the low noise level they assume that a higher x-ray dose has been used than actually has been used. Moreover, individual processings lead to a generation of image artefacts, which may be mistaken for potential features actually present in the image, and/or interpreting processing algorithms, e.g., an automated segmentation and/or classifications of image contents may generate erroneous results. Therefore, it is expedient to make it possible for the user, in as simple and intuitive a way as possible, to assess how greatly and/or in what way the result image data deviates from the processed data, and to adapt the degree of processing and thus the deviation from the origin data as required.

As explained below in relation to the flow diagram in FIG. 2, this is made possible in the processing apparatus 53 or in the method implemented by this by the overall processing algorithm 3, which establishes the result image data 1 from the origin data 2, being parameterized by a control parameter 15. The control parameter 15 is able to be adjusted by an operator input 16 of the users, effectively continuously in the example, between two limit values. In order to make especially intuitive operation possible, a dedicated operating device 52, which is shown by way of example as a slider control, is provided in the example shown in FIG. 1, which makes it possible for the user to adapt the result image data shown on the display facility 51 by setting the control parameter 15 dynamically and almost in real time. As an alternative or in addition to a physical operating device 52, a virtual operating device may be used, for example, when the display facility 51 is embodied as a touchscreen.

What is important here is that the parameter settings 11-13 of the various part algorithms 5-7 may be adapted together by the control parameter 15. Through this, by setting a single parameter, a number of different parts of the processing may be parametrized together. As may be seen, for example, in the graphical representation explained in more detail later of the relationship between the control parameter 15 and the parameter settings 11-13 in FIG. 4, the first limit value 17 of the control parameter 15 is assigned a first value 19 of the parameter setting 11-13 of the respective part algorithm 5-7 and the second limit value 18 is assigned a second value 63 of the parameter setting 11-13 of the respective part algorithm 5-7.

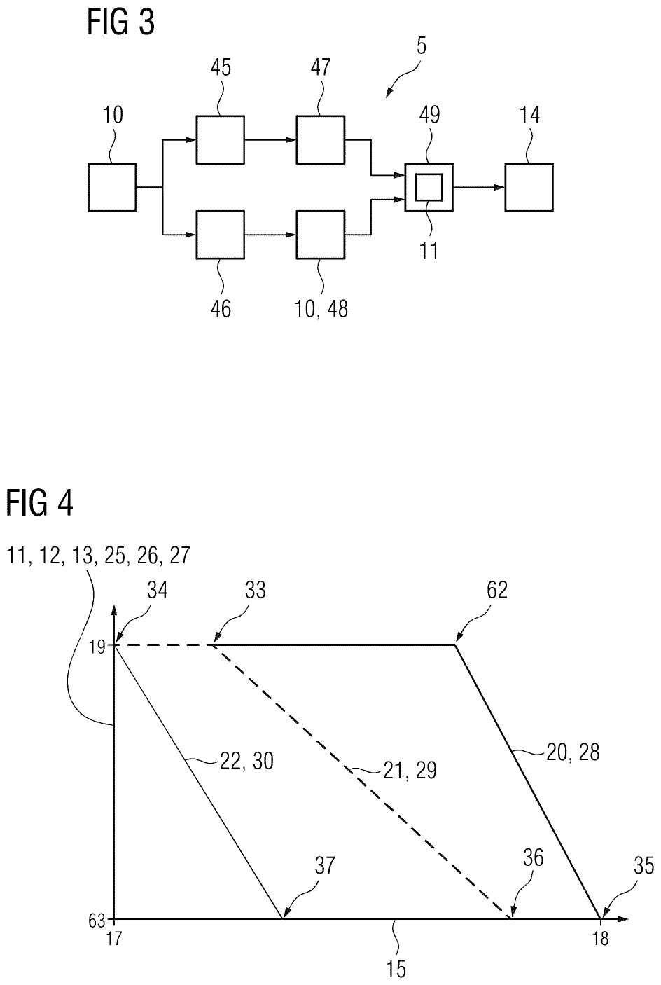

As is shown in FIG. 3 by way of example for the part algorithm 5, respective output data 14 is generated by the respective part algorithm 5-7 as a function of respective input data 10 and of the respective parameter setting 11-13. The respective first and second values 19, 63 of the parameter settings 11-13 assigned to the limit values 17, 18 of the control parameter 15 are selected here in such a way that, at least for origin data that actually images, a patient 59 with reasonable quality, the first value 19 of the parameter setting 11-13 of the respective part algorithm 5-7 leads to the output data 14 of the respective part algorithm 5-7 deviating more greatly from the input data 10 of the respective part algorithm 5-7 than if the second value 63 of the parameter setting 11-13 of the respective part algorithm 5-9 were to be used.

In the example shown, both with the input data 10 and also with the output data 14 of the various part algorithms 5-7, two-dimensional image data is involved in each case. Thus, the deviation of the respective output data 14 from the input data 10 may be quantified by known approaches, for example, as the sum of the squares of the deviation or by the deviation amounts over all pixels of the output data 14. For the sake of completeness, it is pointed out that the actual establishment of such a measure of deviation is not or at least is not necessarily part of the explained method. The definition of the measure of deviation serves exclusively or primarily to define the values 19, 63 of the parameter settings 11-13 assigned to the two limit values 17, 18 or to define a respective assignment specification 20-22 that allocates to the first and second limit value 17, 18 and to intermediate values of the control parameter 15 lying between these, a parameter setting 11-13 of the respective part algorithm 5-7 in each case, within the framework of the development of the method or of a computer program implementing the method.

In particular, when the input data 10, in a variation of the method explained, were to have a different structure from the output data 14, for example, if the part algorithm were to implement a reconstruction of three-dimensional image data from a number of two-dimensional projection images, it may be expedient to compare the output data 14 instead with reference data that would result on application of a reference algorithm assigned to the respective part algorithm 5-9 to the respective input data 10. A n algorithm that carries out the required structural change to the data, such as a reconstruction of a three-dimensional image, with minimal influencing of the image contents, may be regarded as a reference algorithm.

The processing apparatus 53 is implemented in the example by a freely programmable data processing facility 54 with a processor 56 and a memory 57, which executes a suitable computer program 55 that implements the method. The processing apparatus 53 is shown by way of example as a separate component. It is also possible to integrate the processing apparatus 53 into the medical imaging facility 58, to use it together with the display facility 51 as a workstation computer, or to use a remotely connected processing apparatus, for example, a server or a Cloud solution.

Further details and embodiments of the process explained are explained below with regard to what is shown in FIG. 2 of the flow diagram. In act S1, the origin data 2 is received. As explained above, this is undertaken in the example directly by the imaging facility 58. It may also be possible to read out the origin data 2 from a database or to receive it from a further process, which is implemented by the processing apparatus 53.

In act S2, the user may optionally perform an operator input 61 in order to set the configuration information 50, which predetermines which sub-algorithms 41-43 of the overall processing algorithm 3 are to be parametrized as a function of the control parameter 15 and thus form the part algorithms 5-7 already discussed above. In the further explanation, it is assumed here that all of the sub-algorithms 41-43 are selected as part algorithms 5-7. Were one of the sub-algorithms 41-43 to be chosen by the user, then a parameter setting independent on the control parameter and permanently predetermined may be used for this sub-algorithm.

The setting options provided in act S2 may be advantageous since a user potentially wishes that a specific part of the processing, for example, an edge enhancement, is carried out independently of the setting of the control parameter 15. The operator input may be detected via the display facility 51 when this is embodied as a touchscreen, or a further operating device not shown may be used.

In act S3, as explained above, an operator input 16 of the user is detected via the operating device 52. In particular, the following acts S4-S9 may be repeated each time that it is recognized in act S3 that there are changes in the control parameter 15. For as long as no operator input is detected after receipt of the origin data 2, depending on the actual implementation of the method or of the operating device 52, a current setting of the operating device 52 may be read out in order to predetermine the control parameter 15, or alternatively a fixed predetermined value may be used, until the scatter parameter 15 is actively set by the user.

In act S4, the parameter setting 11-13 of the respective part algorithm 5-7 is predetermined as a function of the control parameter 15 by a respective assignment specification 20-22. Here, in the example, the parameter value 25-27 of at least one parameter of the respective part algorithm 5-7 is predetermined by a respective monotonously falling function 28-30 of the control parameter 15 shown in FIG. 4 as the respective parameter setting 11-13. In the example, the individual functions 28-30 each remain constant over specific ranges of values of the control parameter 15 and each fall over a certain area of the range of values linearly from the respective maximum 33, 34, 62 to a respective minimum 35-37.

A value for the parameter λ may be predetermined as the respective parameter value 25-27 in order to set the respective processing in the respective part algorithm 5-7 from “no effect” at λ=0 up to a maximum effect at λ=1, as explained below with regard to acts S6-S8.

As has already been explained with regard to act S2, by a corresponding operator input 61 a user may establish the influence of the control parameter 15 and thus deactivate the parameter settings 11-13 established in act S4 in individual sub-algorithms 41-43 or part algorithms 5-7. For sub-algorithms 41-43 that are not to depend on the control parameter 15, thus, in act S5, instead of the predetermined parameter setting 11-13 in act S4, a respective permanent parameter setting may be predetermined.

The acts S6 to S8 implement the individual part algorithms 5-7 or sub-algorithms 41-43, which are executed in the example sequentially after one another, so that the part algorithm 5 processes the origin data 2 as input data 10, while the part algorithms 6 and 7 executed thereafter further process the output data 14 of the respective preceding part algorithm 5 or 6.

In the example, the part algorithm 5 executed in act S6 implement a reduction of the low-frequency dynamic, which may be implemented by a scaling of low-frequency frequency components, for example, by subtraction of a lowpass image. The scaling of this processing by the parameter value 25 of the parameter λ has already been discussed above.

An approach for attenuating the processing as a function of the parameter value 11 is shown schematically in FIG. 3 by way of example for the part algorithm 5. The part algorithm 5 here includes a first and a second alternative algorithm 45, 46, which each process the input data 10 in order to provide respective alternative data 47, 48. In the example the alternative algorithm 45 implements the subtraction of a lowpass-filtered image explained above and thus the non-attenuated processing.

The alternative algorithm 46, which is to provide the output data 14 for maximum attenuation of the processing by the parameter value 11, may in the simplest case not carry out any data processing, so that the alternative data 48 may in particular correspond to the input data 10. As an alternative it would also be possible to uses a type of reference algorithm as an alternative algorithm 46 that, although it carries out data processing, remains here as close as possible to the original image or to the input data 10 in order to robustly avoid a corruption of the image.

The output data 14 may be provided by a cross fading 49 between the alternative data 47, 48 of the first and the second alternative algorithm 45, 46 as a function of the parameter setting 11-13, for example, by a sum weighted as a function of the parameter value 11 of the alternative data 47,48.

If the reduction of the low-frequency dynamic is implemented by the explained subtraction of a lowpass-filtered image, then the cross fading explained with regard to FIG. 3 between alternative data 47, 48 is equivalent to the direct parameterization of the dynamic reduction. For various part algorithms, various approaches for fading out the respective processing may be advantageous. For example, with a non-linear processing an explicit parameterization compared to the explained cross fading may be advantageous. The advantage of the explained cross fading is that the alternative algorithms 47, 48 may be complex and difficult to parametrize to any given degree. Via the explained cross fading 49, for example, it is possible to attenuate the processing strength of an algorithm trained by machine learning without problems and/or it is even possible to implement a cross fading between various algorithm types, for example, between a filtering for noise reduction and an algorithm trained by machine learning for noise reduction.

The part algorithm 6 carried out in act S7 implements an edge enhancement by raising high frequencies in the input data 10. A realization by the scaled addition of a highpass image and a suitable parameterization by the parameter value 26 of a parameter λ has been described above.

In act S8, an interpreting algorithm is used as a part algorithm 7, which automatically segments the input data 10 and highlights specific segments, for example, a vessel system of the patient 59, e.g., marks it by a surround. Algorithms for automatic segmentation are well known per se. They may be implemented both in the usual way and also by a trained algorithm.

Since such an algorithm may involve a complex algorithm, it may be advantageous to use the cross fading between alternative data 47, 48 explained with regard to FIG. 3 in order to attenuate the processing as a function of the parameter setting 13. In one case, as already explained, there may be a cross fading to the input data 10 for attenuation of the processing strength. A corresponding segmentation may also be required and, for example, there may just be a switch between an algorithm trained by machine learning and a conservative, manually implemented algorithm as a function of the parameter value 27.

In the example, the parameter value 25 for the part algorithm 5 is predetermined by the assignment specification 20, the parameter value 26 for the part algorithm 6 by the assignment specification 21 and the parameter value 27 for the part algorithm 7 by the assignment specification 22. As may be seen in FIG. 4, all parameter values 25-27 thus have their maximum 33, 34, 62 when the control parameter 15 is set to the limit value 17, whereby a maximum processing strength is set in all part algorithms 5-7 and thus for the overall processing algorithm 3.

Then, for an adjustment of the control parameter from limit value 17 toward limit value 18, the parameter value 27 for the part algorithm 7 is lowered, whereby only the interpreting data processing, which may lead to an especially strong deviation of the image impression from the origin data, is attenuated or faded out.

Only with a value of the control parameter 15 at which the parameter value 27 is already largely lowered to its minimum 37 does the lowering of the parameter value 26 and thus a reduction of the edge enhancement begin.

A lowering of the parameter value 25 and thus a reduction of the attenuation of the low-frequency dynamic only takes place relatively close to the limit value 18 of the control parameter 15, since a change in the low-frequency area of the image spectrum may lead to a significantly lower artifact formation than may result with a change in the high-frequency area, for example, with the edge enhancement in the example.

The process described thus makes it possible for the user to set the degree of processing and thus the strength of the deviation of the result image data 1 from the origin data 2 effectively continuously. This enables the degree of processing to be adapted dynamically to the current requirements of the user and the user may quickly and with little effort obtain an impression of how greatly the processing of the origin data 2 is changing the data or is corrupting or affecting an image impression. In order to make the degree of the processing detectable for a user even when they are not paying attention to the operating device, it may be expedient to show the control parameter 15 together with the result image data 1 on the display 51, for example, as a numerical value or as a bar graphic.

FIG. 5 shows a further possibility of implementing an overall processing algorithm 4 in such a way that the degree of processing of the origin data 2 may be varied effectively continuously for provision of the result image data 1. The overall processing algorithm 4 here implements a complex spectral shaping, in which different frequency ranges of the origin data 2 are weighted differently in the result image data 1. The overall processing algorithm 4 may carry out the entire data processing, but it is also possible to combine it with further part algorithms. For example, the overall algorithm 4 may be used to implement the spectral shaping in the acts S7 and S8 in the overall algorithm explained previously with regard to FIG. 2.

The overall processing algorithm 4 shown schematically in FIG. 5, as well as the part algorithms 8, 9, includes a spectral decomposition algorithm 44, which provides as output data a number of spectral components 38-40 of the origin data 2. The spectral decomposition may be undertaken, for example, by a Gauss-Laplace pyramid.

In the example, the spectral component 38 includes the high-frequency spectral components, the spectral component 39 includes the mid spectral range, and the spectral component 40 includes the low-frequency spectral components. In the example, only the spectral components 38,40 are processed by a respective part algorithm 8, 9, after which the output data of these part algorithms 8, 9 is combined with the unchanged spectral components 39 by a recombination algorithm 60, for example, by a summation, in order to provide the result image data 1.

In the example, the part algorithms 8, 9 each carry outa scaling of the respective spectral component 38, 40. In the setting of the control parameter 15 to a first limit value 17 here there may be the maximum degree of processing. In the example, the part algorithm 8 increases the amplitude of the spectral component 38 here in order to implement an edge enhancement, and the part algorithm 9 lowers the amplitude of the spectral component 40 in order to implement a reduction of a low-frequency dynamic.

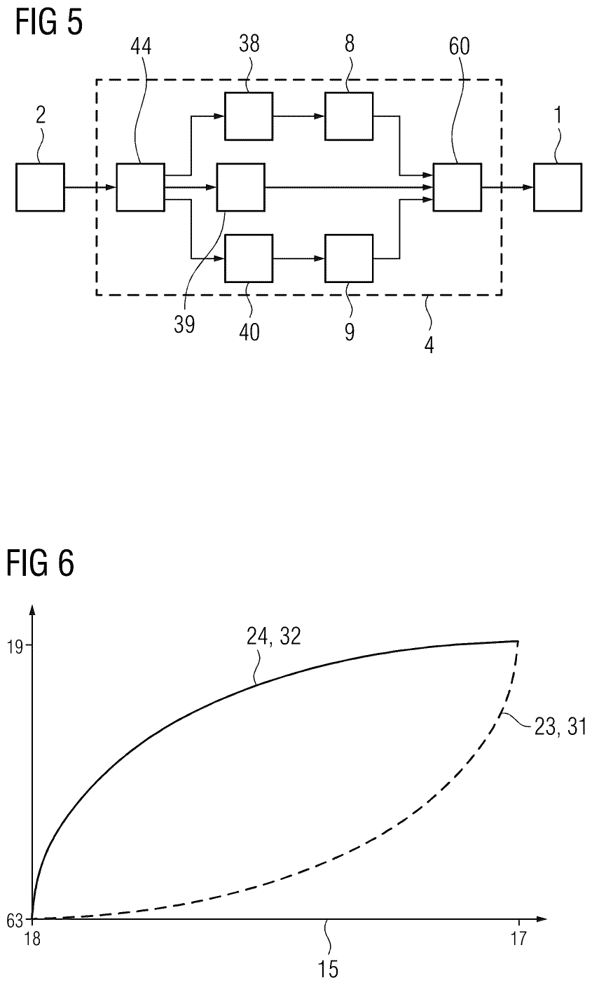

The strength of the processing and thus the parameter setting for the part algorithm 8 are predetermined in the example by the assignment specification 23 shown in FIG. 6 or monotonous function 31, while the strengths of the processing and thus the parameter setting for the part algorithm 9 is predetermined by the assignment specification 24 shown there or the monotonous function 32. The different curvatures of the functions 31, 32 lead, with a reduction of the control parameter 15 starting from the limit value 17 initially lead primarily to the processing by the part algorithm 8 being attenuated and thus to the intervention in the high-frequency range, while the parameter setting of the part algorithm 9 and thus the degree of suppression of the low-frequency dynamic initially remains the same. The lowering of the low-frequency dynamic is only increasingly reduced as the proximity of the control parameter 15 to the limit value 18 increases.

Similarly to the different positioning of the maxima 33, 34,62 and minima 35-37 of the various assignment specifications 28-30 used in FIG. 4, it may also be achieved by different curvatures of the assignment specifications 13, 32 that with a change of the control parameter 15, starting from a maximum processing, initially any types of processing that may potentially lead to a corruption or artefact formation are especially strongly suppressed. It is also possible to combine both approaches, e.g., in FIG. 4 to additionally use different curvatures of the various functions 28-30.

It is to be understood that the elements and features recited in the appended claims may be combined in different ways to produce new claims that likewise fall within the scope of the present disclosure. Thus, whereas the dependent claims appended below depend on only a single independent or dependent claim, it is to be understood that these dependent claims may, alternatively, be made to depend in the alternative from any preceding or following claim, whether independent or dependent, and that such new combinations are to be understood as forming a part of the present specification.

While the present disclosure has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A computer-implemented method for generation of result image data from origin data, which is based on a medical imaging method, by an overall processing algorithm comprising part algorithms, the method comprising:
generating, by each part algorithm of the part algorithms, respective output data as a function of respective input data and of at least one respective parameter setting, wherein the input data of the part algorithms is predetermined by the origin data or is established from the origin data; and
establishing the result image data as a function of the output data of the part algorithms,
wherein a parameter setting is predetermined for at least one part algorithm as a function of a control parameter of the overall processing algorithm,
wherein the control parameter is adjustable by an operator input of a user, continuously or in at least three stages, between a first limit value and a second limit value,
wherein the first limit value is assigned a first value of the parameter setting,
wherein the second limit value is assigned a second value of the parameter setting for the at least one part algorithm, and
wherein setting of the first value of the parameter setting for the at least one part algorithm at least for one subgroup of possible origin data leads to the output data of the at least one part algorithm or a number of part algorithms deviating more greatly from the input data or from reference data, which would result on application of a reference algorithm assigned to the at least one part algorithm or to the number of part algorithms to the input data, than with setting the second value of the parameter setting.

2. The computer-implemented method of claim 1, wherein the respective part algorithm is assigned a respective assignment specification having a parameter setting of the part algorithm assigned to the first limit value, the second limit value, and at least one intermediate value of the control parameter lying between the first limit value and the second limit value in each case, and
wherein assignment specifications assigned to at least two part algorithms of the part algorithms describe relations between the respective parameter setting and the respective control parameter differing from one another in each case.

3. The computer-implemented method of claim 1, wherein the respective parameter setting predetermines a respective parameter value of at least one parameter of the respective part algorithm, and
wherein the respective parameter value is a monotonously rising or falling function of the control parameter in each case.

4. The computer-implemented method of claim 3, wherein a maximum of the at least one parameter value of the parameter setting of a first part algorithm of the part algorithms is reached for value of the control parameter other than a maximum of the at least one parameter value of the parameter setting of a second part algorithm of the part algorithms, and/or
wherein a minimum of the at least one parameter value of the parameter setting of the first part algorithm of the part algorithms is reached for a value of the control parameter other than for a minimum of the at least one parameter value of the parameter setting of the second part algorithm of the part algorithms.

5. The computer-implemented method of claim 3, wherein at least two of the functions, which each predetermine a parameter value of different part algorithms or different parameter values of a same part algorithm as a function of the control parameter over an entire range of values of the control parameter or at least over a part of the entire range of values of the control parameter, have a curvature different from one another and different from zero.

6. The computer-implemented method of claim 3, wherein the overall processing algorithm comprises a processing algorithm based on a segmentation and/or classification of the respective input data as a first part algorithm of the part algorithms, or a processing algorithm based on machine learning and a filter algorithm as a second part algorithm of the part algorithms, and
wherein the functions of the control parameter predetermining the parameter values of the first part algorithm and the second part algorithm are chosen such that, at least for control parameters that lie within a predetermined control parameter interval, an amount of a quotient of a difference between the parameter value assigned to the control parameter and the parameter value corresponding to the second value of the parameter setting and a difference between the parameter values assigned to the respective first value and the second value of the parameter setting is greater for the second part algorithm than for the first part algorithm.

7. The computer-implemented method of claim 3, wherein the overall processing algorithm comprises, as part algorithms, a first filter algorithm for adaptation of spectral components in a first frequency band, a second filter algorithm for adaptation of spectral components in a second frequency band of the origin data, or an intermediate result established using at least one further part algorithm of the part algorithms,
wherein the first frequency band extends to higher frequencies than the second frequency band, and
wherein the functions of the control parameter predetermining the parameter values of the first filter algorithm and the second filter algorithm are chosen such that, at least for control parameters that lie within an interval or a further predetermined control parameter interval, an amount of a quotient of a difference between the parameter value assigned to the control parameter and the parameter value corresponding to the second value of the parameter setting and a difference between the parameter values assigned to the respective first value and the second value of the parameter setting is greater for the second filter algorithm than the first filter algorithm.

8. The computer-implemented method of claim 1, wherein the overall processing algorithm comprises at least one of the following part algorithms: an algorithm for edge enhancement, a filter algorithm for reduction of a low-frequency dynamic, a processing algorithm based on a segmentation and/or classification of the respective input data, or a processing algorithm based on machine learning and/or a scaling of the input data.

9. The computer-implemented method of claim 1, wherein the overall processing algorithm comprises a spectral decomposition algorithm that provides as output data a number of spectral components of the origin data or of an intermediate result established using at least one part algorithm of the part algorithms, and
wherein at least one spectral component of the spectral components is processed as input data by one part algorithm of the part algorithms.

10. The computer-implemented method of claim 1, wherein at least one part algorithm of the part algorithms comprises a first alternative algorithm and a second alternative algorithm,
wherein each respective alternative algorithm of the first and second alternative algorithms is configured to process the input data in order to provide respective alternative data, and
wherein, by way of the parameter setting of the respective part algorithm, a choice is made to use the respective alternative data of the first alternative algorithm or the second alternative algorithm as output data, or
wherein the output data is provided by a cross fading between the alternative data of the first alternative algorithm and the second alternative algorithm as a function of the parameter setting.

11. The computer-implemented method of claim 1, wherein the overall processing algorithm comprises a number of sub-algorithms,
wherein a respective sub-algorithm of the sub-algorithms generates respective output data as a function of respective input data and a respective parameter setting,
wherein the input data of the respective sub-algorithm is predetermined by the origin data or established from the origin data by using at least one other sub-algorithm of the sub-algorithms, and
wherein the part algorithms are chosen as a function of configuration information from the sub-algorithms.

12. The computer-implemented method of claim 1, wherein the control parameter is output via a display facility to the user, and/or
wherein the control parameter is set based on a user input of the user detected via an operating device.

13. A processing apparatus comprising:
a processor; and
a memory,
wherein the processor and the memory are configured to:
generate, by each part algorithm of part algorithms of an overall processing algorithm, respective output data as a function of respective input data and of at least one respective parameter setting, wherein the input data of the part algorithms is predetermined by origin data or is established from the origin data; and
establish the result image data as a function of the output data of the part algorithms,
wherein a parameter setting is predetermined for at least one part algorithm as a function of a control parameter of the overall processing algorithm,
wherein the control parameter is adjustable by an operator input of a user, continuously or in at least three stages, between a first limit value and a second limit value,
wherein the first limit value is assigned a first value of the parameter setting,
wherein the second limit value is assigned a second value of the parameter setting for the at least one part algorithm, and
wherein setting of the first value of the parameter setting for the at least one part algorithm at least for one subgroup of possible origin data leads to the output data of the at least one part algorithm or a number of part algorithms deviating more greatly from the input data or from reference data, which would result on application of a reference algorithm assigned to the at least one part algorithm or to the number of part algorithms to the input data, than with setting the second value of the parameter setting.

14. A non-transitory data medium comprising a computer program with instructions that are configured, when executed on a data processing facility, to:
generate, by each part algorithm of part algorithms of an overall processing algorithm, respective output data as a function of respective input data and of at least one respective parameter setting, wherein the input data of the part algorithms is predetermined by origin data or is established from the origin data; and
establish the result image data as a function of the output data of the part algorithms,
wherein a parameter setting is predetermined for at least one part algorithm as a function of a control parameter of the overall processing algorithm,
wherein the control parameter is adjustable by an operator input of a user, continuously or in at least three stages, between a first limit value and a second limit value,
wherein the first limit value is assigned a first value of the parameter setting,
wherein the second limit value is assigned a second value of the parameter setting for the at least one part algorithm, and
wherein setting of the first value of the parameter setting for the at least one part algorithm at least for one subgroup of possible origin data leads to the output data of the at least one part algorithm or a number of part algorithms deviating more greatly from the input data or from reference data, which would result on application of a reference algorithm assigned to the at least one part algorithm or to the number of part algorithms to the input data, than with setting the second value of the parameter setting.
